(19) United States
(12) Patent Application Publication
(10) Pub. No.: US 2004/0246876 A1
(43) Pub. Date: Dec. 9, 2004

(54) Optical pickup apparatus comprising optical device with phase shift coating layer

(75) Inventors: Ki-Bok Kim, Suwon-si (KR); No-jun Kwak, Suwon-si (KR); Sun-mook Park, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/784,881

(22) Filed: Feb. 24, 2004

(30) Foreign Application Priority Data
Feb. 25, 2003 (KR) 2003-11635

(51) Int. Cl. G11B 7/135

(52) U.S. Cl. 369/112.23

(57) ABSTRACT

An optical pickup apparatus including a first light source to emit light; light transmitting and/or reflecting units to affect the emitted light as the emitted light is transmitted and/or reflected to an optical information storage medium; and a phase shift coating layer provided on at least one of the light transmitting and/or reflecting units to change a polarization state of the emitted light.

### CROSS-REFERENCE TO RELATED APPLICATIONS

This application claims the benefit of Korean Patent Application No. 2003-11635, filed on Feb. 25, 2003, in the Korean Intellectual Property Office, the disclosure of which is incorporated herein by reference.

### BACKGROUND OF THE INVENTION

1. Field of the Invention

The present invention relates to an optical pickup apparatus, and, more particularly, to an optical pickup apparatus comprising an optical device with a phase shift coating layer.

2. Description of the Related Art

In optical recording/reproducing apparatuses utilizing optical information storage media, such as digital versatile disks (DVDs) or compact disks (CDs), an optical pickup apparatus projects a light emitted from a light source onto an optical information storage medium to record data on the optical information storage medium, and detects the light reflected by the optical information storage medium to reproduce data recorded on the optical information storage medium. The light reflected by the optical information storage medium re-enters the light source and interferes with subsequent light emitted from the light source, thereby causing noise. In particular, when the optical pickup apparatus operates at a high multiple speed, it requires high optical power, thus increasing the light noise.

FIG. 1 is a schematic configurational view of a conventional optical pickup apparatus including a λ/4 plate to solve the above problem. Referring to FIG. 1, the conventional optical pickup apparatus includes a first and a second light sources 11a and 11b, a cubic beam splitter 17, a flat beam splitter 27, a λ/4 plate 19, an objective lens 25, and a photodetector 61. The cubic beam splitter 17 and the flat beam splitter 27 convert the travel paths of lights emitted from the first and the second light sources 11a and 11b, respectively. The λ/4 plate 19 changes the polarization state of the light emitted from each of the cubic beam splitter 17 and the flat beam splitter 27. The objective lens 25 focuses the light transmitted by the λ/4 plate 19 on an optical information storage medium 63. The photodetector 61 detects information from the light reflected by the optical information storage medium 63.

A grating 13, which splits a light path, and a first collimating lens 15, which collimates an incident light, are provided between the first light source 11a and the cubic beam splitter 17. A mirror 21 and a second collimating lens 23 are provided between the λ/4 plate 19 and the objective lens 25. The mirror 21 reflects incident light toward the optical information storage medium 63, and the second collimating lens 23 collimates the light reflected by the mirror 21. A sensor lens 29 may be further provided between the flat beam splitter 27 and the photodetector 61, so as to alleviate a phase difference of the incident light beams which are focused on the photodetector 61.

In the conventional optical pickup apparatus, by providing the λ/4 plate 19 between the optical information storage medium 63 and the first and second light sources 11a and 11b, the polarization direction of a light emitted from the first and second light sources 11a and 11b is changed from a linearly-polarized light (e.g., a P-polarized light) to left-handed or right-handed circularly polarized light. The left-handed circularly polarized light is changed to a right-handed circularly polarized light after passing through the λ/4 plate 19, and the right-handed circularly polarized light is changed to left-handed circularly polarized light after passing through the λ/4 plate 19. Thereafter, after the light is reflected from the optical information storage medium 63 the direction-changed circularly polarized light is converted into another type of linearly polarized light (e.g., an S-polarized light) while passing back through the λ/4 plate 19. The linearly polarized light returns to the first and second light sources 11a and 11b. Because the returned light and the emitted light have different polarization states, interference between the returned light and the emitted light does not occur, thus decreasing the light noise.

However, due to the use of next-generation optical information storage media such as high-density DVDs (HD-DVDs), optical information recording/reproducing apparatuses must be able to adopt a plurality of light sources providing lights in different wavelength bands, and to use the next-generation optical information storage media compatibly with conventional optical information storage media. Accordingly, more recently developed optical pickup apparatuses must be able to reduce the light noise while dealing with all light sources that provide lights in different wavelength bands. However, there is a limit in reducing the light noise by using a λ/4 plate. In addition, an optical pickup apparatus capable of reducing the light noise without adopting an extra optical element is desired to obtain a compact, light optical pickup apparatus and to reduce an assembly tolerance.

### SUMMARY OF THE INVENTION

The present invention provides an optical pickup apparatus to remove light noise by shifting the optical phase of light using a simple optical member.

Additional aspects and/or advantages of the invention will be set forth in part in the description which follows and, in part, will be obvious from the description, or may be learned by practice of the invention.

According to an aspect of the present invention, there is provided an optical pickup apparatus, the optical pickup apparatus including a light source to generate and emit light, an objective lens to converge the light emitted from the light source on an optical information storage medium, a light path converter to convert the light emitted from the light source and light reflected from the optical information storage medium, a collimating lens to collimate the light emitted from the light source, a photodetector to detect information by receiving the light reflected by the optical information storage medium and by photoelectrically transforming the received light, wherein a phase shift coating layer is provided on at least one of the light source, the objective lens, the light path converter, and the collimating lens, to change a polarization state of the light emitted from the light source and a polarization state of the light reflected by the optical information storage medium.

The phase shift coating layer may reflect incident light beams with different wavelengths so that the incident light beams have an identical phase difference. Alternatively, the phase shift coating layer may reflect an incident light beam with a specific wavelength so that the incident light beam has a specific phase difference.

The phase shift coating layer may comprise at least 30 layers of same or different materials.

The light path converter may be either a flat beam splitter or a cubic beam splitter.

The phase shift coating layer may be formed on a window of the light source.

According to another aspect of the present invention, there is provided an optical apparatus including a first light source to emit light, light transmitting and/or reflecting units to affect the emitted light as the emitted light is transmitted and/or reflected to an optical information storage medium, and a phase shift coating layer provided on at least one of the light transmitting units to change a polarization state of the emitted light.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic configurational view of a conventional optical pickup apparatus;

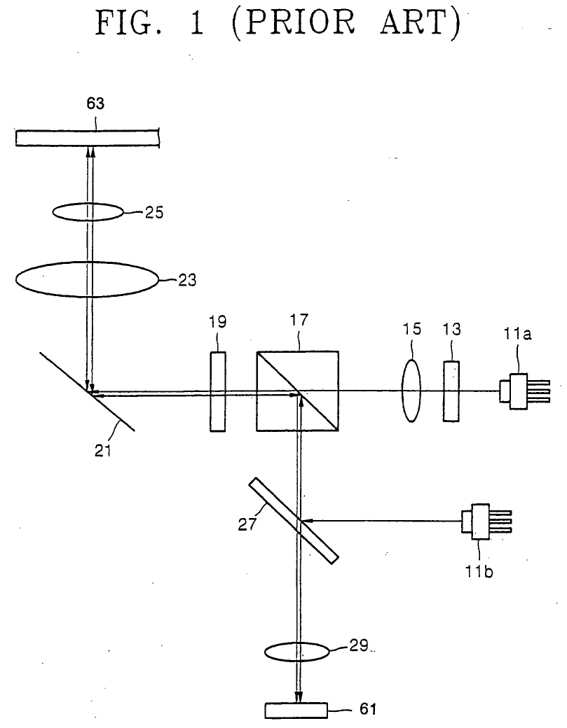

FIG. 2 is a schematic configurational view of an optical pickup apparatus according to an embodiment of the present invention; and

FIG. 3 is a schematic graph showing a P-polarized light, an S-polarized light, and a phase difference between the P- and S-polarized lights versus the wavelengths of light emitted from a light source.

### DETAILED DESCRIPTION OF THE PREFERRED EMBODIMENTS

Reference will now be made in detail to the embodiments of the present invention, examples of which are illustrated in the accompanying drawings. The embodiments are described below to explain the present invention by referring to the figures.

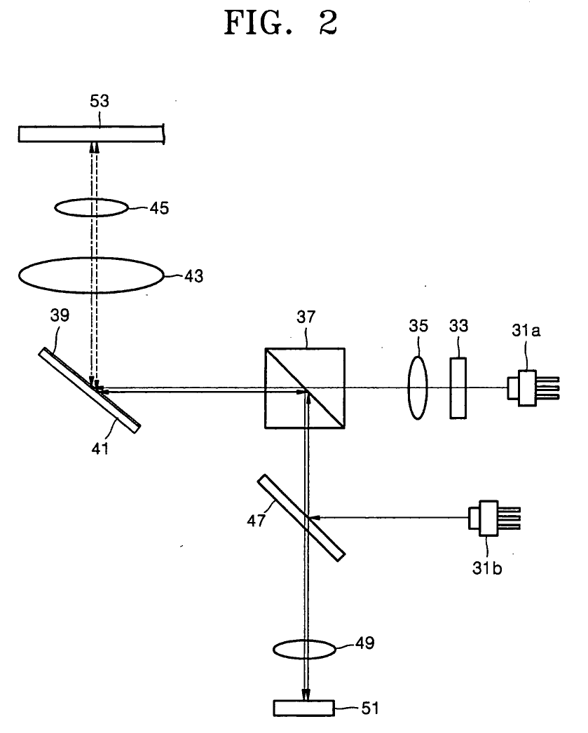

Referring to FIG. 2, in an optical pickup apparatus according to an embodiment of the present invention, a phase shift coating layer 39 is formed on a mirror 41 to change linearly polarized light (P- or S-polarized light), emitted from first and second light sources 31a and 31b, to left-handed or right-handed circularly polarized light. The mirror 41 reflects the linearly polarized light emitted from the first and second light sources 31a and 31b toward an optical information storage medium 53. The left-handed or right-handed circularly polarized light is changed to circularly polarized light when reflected in the opposite direction by the optical information storage medium 53. Also, the phase shift coating layer 39 changes the left-handed or the right-handed circularly polarized light, reflected by the optical information storage medium 53, to linearly polarized light (S- or P-polarized light).

For example, if light emitted from the first light source 31a is P-polarized light, it is changed to left-handed circularly polarized light by the phase shift coating layer 39, and the left-handed circularly polarized light is also changed to right-handed circularly polarized light after being reflected by the optical information storage medium 53. The right-handed circularly polarized light re-enters the phase shift coating layer 39 and is changed to an S-polarized light while passing through the phase shifting coating layer 39. The S-polarized light re-enters the first light source 31a. Because the polarization states of the light emitted from the first light source 31a and the re-entered light are different, the light noise generated in the optical pickup apparatus can be completely removed.

The optical pickup apparatus of FIG. 2 includes the first and second light sources 31a and 31b, first and second light path converters 37 and 47, the phase shift coating layer 39, the mirror 41, and an objective lens 45. The first and the second light sources 31a and 31b emit light for CDs (e.g., laser light with a 780 nm wavelength band) and light for DVDs (e.g., laser light in a 650 nm wavelength band), respectively. The first and second light path converters 37 and 47 transmit or reflect light emitted from the first and second light sources 31a and 31b so that the incident light is separated in two directions. The mirror 41 has the phase shift coating layer 39 coated thereon, and reflects light received from the light path converters 37 and 47 toward the optical information storage medium 53. The objective lens 45 focuses the light reflected by the mirror 41 on the optical information storage medium 53.

A grating 33 and a first collimating lens 35 are further provided between the first light source 31a and the first light path converter 37. The grating 33 divides the light emitted from the first light source 31a into zero^{th}-order light and ±1^{st}-order light, which have different diffraction angles and different light paths. The first collimating lens 35 collimates the zero^{th}-order light and the ±1^{st}-order light. A second collimating lens 43, to collimate light that travels toward the optical information storage medium 53, is further provided between the mirror 41 and the objective lens 45.

The grating 33 enables a photodetector 51 to detect a tracking error signal using a three-beam detection method. If the photodetector 51 reproduces optical information using other detection methods, the grating 33 may not be necessary. If the light emitted from the first light source 31a is laser light for CDs, and the optical information storage medium 53 is a CD, the photodetector 51 receives the laser light reflected by the CD and performs photoelectric transformation on the received laser light. The first collimating lens 35 is installed to reduce the focal distance of the light for CDs. A sensor lens 49 may be further provided between the second light path converter 47 and the photodetector 51, so as to control the position thereof for focusing the light beam impinging thereon on the photodetector 51.

Preferably, but not necessarily, the first and second light sources 31a and 31b are semiconductor lasers which emit light polarized in one direction, that is, linearly polarized laser light as P- or S-polarized light. The first and second light sources 31a and 31b may be semiconductor lasers which emit laser light for CDs and laser light for DVDs, respectively, or semiconductor lasers which emit laser light for DVDs and laser light for high-density DVDs (HD-DVDs), respectively. Although not shown in FIG. 2, the optical pickup apparatus may further include a third light source in order to cover three types of optical information storage media, such as a CD, a DVD, and an HD-DVD. Instead of separately providing the first and second light sources 31a and 31b, a single optical module, that is, a twin laser diode (twin-LD), may be provided. The type and number of light sources in the present invention are not limited to the optical pickup apparatus of FIG. 2.

Although the first and second light path converters 37 and 47 are a cubic beam splitter and a flat beam splitter, respectively, in FIG. 2, this does not limit the present invention to the configuration presented, and they may be switched.

The mirror 41 reflects incident light so that the direction of the incident light is changed by 90 degrees. However, in the optical pickup apparatus of FIG. 2, light noise can be reduced just by the phase shift coating layer 39 formed on the mirror 41. When considering windows (not shown) of the first and second light sources 31a and 31b, through which light is emitted, the phase shift coating layer 39 may be formed on each of the grating 33, the first and second collimating lenses 35 and 43, the objective lens 45, and the first and second light path converters 37 and 47. In this case, when a plurality of light sources to emit light beams in a plurality of wavelength bands are adopted, a phase difference between light beams in different wavelength bands is limited to a predetermined range, thereby effectively controlling the light noise.

In general, a 180° phase delay (difference) is generated when a light beam is reflected by a reflection material. A mirror can reflect light beams in different wavelength bands to obtain different desired phase delays, depending on a coating design technique. If a 90° phase delay is obtained, the mirror can have the effect of a ¼ wavelength plate (a λ/4 plate).

The phase shift coating layer 39 formed on the mirror creates a 90° phase delay between P- and S-polarized lights so as to have the effect of a ¼ wavelength plate. The phase shift coating layer 39 can be formed on a plurality of optical elements to increase a light noise reduction effect.

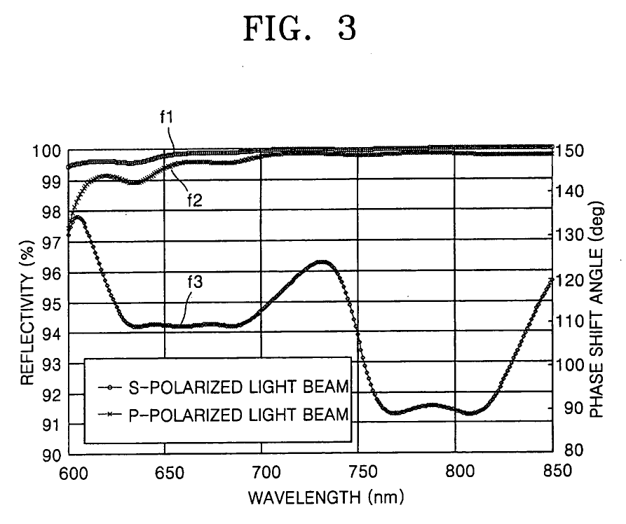

FIG. 3 is a schematic graph showing a P-polarized light, an S-polarized light, and a phase difference between the P- and S-polarized lights versus the wavelengths of light emitted from a light source.

In FIG. 3, f1 denotes an S-polarized light, f2 denotes a P-polarized light, and f3 denotes a phase difference between the P- and S-polarized lights. As shown in FIG. 3, the reflectivity of each of the P- and S-polarized lights reflected by the phase shift coating layer 39 is close to 100%, and the phase shift angle of each of the P- and S-polarized lights is about 150°. The phase difference f3 between the P- and S-polarized lights is about 94% around 650 nm wavelength (laser light for DVDs) and about 91% around 780 nm wavelength (laser light for CDs). In other words, when the optical pickup apparatus of FIG. 2 adopts a semiconductor laser for CDs as the first light source 31a, and a semiconductor laser for DVDs as the second light source 31b, the phase shift coating layer 39 converts the polarization states of P- or S-polarized light in a 650 nm wavelength band and P- or S-polarized light in a 780 nm wavelength band. As shown in FIG. 3, the phase shift coating layer 39 changes the light beam impinged thereonto into the light beams having the phase difference of 90 degrees without depending on the wavelengths, i.e., 650 nm and 780 nm. Thus, it can be predicted that light noise is effectively reduced.

In the above-described optical pickup apparatus according to the present invention, a phase shift coating layer is formed on an optical device instead of adopting a λ/4 plate as a separate optical device. Thus, upon formation of an optical system, each optical device can occupy a sufficient space and is easily located. Also, a small, light optical pickup apparatus can be manufactured at a low cost. Furthermore, light noise can be effectively reduced even in a plurality of wavelength bands. As a result, it is possible to obtain an optical information recording and reproducing apparatus which can compatibly deal with a plurality of optical information storage media such as CDs, DVDs, and HD-DVDs.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical pickup apparatus comprising:
a light source to generate and emit light;
an objective lens to converge the light emitted from the light source on an optical information storage medium;
a light path converter to convert the light emitted from the light source and light reflected from the optical information storage medium;
a collimating lens to collimate the light emitted from the light source; and
a photodetector to detect information by receiving the light reflected by the optical information storage medium and by photoelectrically transforming the received light,
wherein a phase shift coating layer is provided on at least one of the light source, the objective lens, the light path converter, and the collimating lens, to change a polarization state of the light emitted from the light source and a polarization state of the light reflected by the optical information storage medium.

2. The optical pickup apparatus of claim 1, wherein the phase shift coating layer reflects incident light beams at a same phase difference without depending on wavelengths.

3. The optical pickup apparatus of claim 1, wherein the phase shift coating layer is coated such that a phase shift corresponding to a required wavelength bandwidth is produced.

4. The optical pickup apparatus of claim 1, wherein the phase shift coating layer comprises at least 30 layers of same or different materials.

5. The optical pickup apparatus of claim 1, wherein the light path converter is a flat beam splitter.

6. The optical pickup apparatus of claim 1, wherein the light path converter is a cubic beam splitter.

7. The optical pickup apparatus of claim 1, wherein the phase shift coating layer is formed on a window of the light source.

8. An optical pickup apparatus comprising:
a light source to emit light;
a mirror to reflect the emitted light toward an optical information storage medium; and
a phase shift coating layer provided on the mirror to change a polarization state of the light emitted from the light source.

9. The optical pickup apparatus of claim 8, wherein the light emitted from the light source is linearly polarized light, and the phase shift coating layer changes the linearly polarized light to left-handed or right-handed circularly polarized light.

10. The optical pickup apparatus of claim 8, wherein the phase shift coating layer also changes a polarization state of light reflected from the optical information storage medium.

11. An optical pickup apparatus comprising:
a first light source to emit light;
light transmitting and/or reflecting units to affect the emitted light as the emitted light is transmitted and/or reflected to/from an optical information storage medium; and
a phase shift coating layer provided on at least one of the light transmitting and/or reflecting units to change a polarization state of the emitted light.

12. The optical pickup apparatus of claim 11, wherein light reflected to the light source has a different polarization state than the emitted light, so that light noise is reduced.

13. The optical pickup apparatus of claim 11, wherein the light transmitting and/or reflecting units comprise at least one of a light path converter, a collimating lens, a mirror, and an objective lens.

14. The optical pickup apparatus of claim 13, wherein the light path converter transmits or reflects the emitted light so that incident light is separated in two directions.

15. The optical pickup apparatus of claim 13, wherein the mirror reflects the emitted light toward the optical storage medium.

16. The optical pickup apparatus of claim 13, wherein the objective lens focuses the emitted light on the optical information storage medium.

17. The optical apparatus of claim 13, wherein the light transmitting and/or reflecting units further comprise a grating to divide the emitted light into zero^{th}-order light and ±1^{st}-order light, which have different diffraction angles and different light paths.

18. The optical apparatus of claim 11, further comprising a second light source to emit light for DVDs, wherein the light emitted from the first light source is light for CDs.

19. The optical apparatus of claim 18, further comprising a third light source to emit light for HD-DVDs.

20. The optical apparatus of claim 11, wherein the first light source comprises a twin laser diode to emit a plurality of types of light for a plurality of optical information storage media.

21. The optical apparatus of claim 11, wherein the phase shift coating layer creates a 90° phase delay between P- and S-polarized lights.
